(19) United States
(12) Patent Application Publication
(10) Pub. No.: US 2014/0236810 A1
(43) Pub. Date: Aug. 21, 2014

(54) METHOD AND SYSTEM FOR DETERMINING MOST REWARDING CHOICE OF PAYMENT AT A POINT-OF-SALE

(71) Applicants: Amit Ramchandran, San Jose, CA (US); Amir Masoud Zarkesh, Saratoga, CA (US); Saeid Ghafouri, Saratoga, CA (US)

(72) Inventors: Amit Ramchandran, San Jose, CA (US); Amir Masoud Zarkesh, Saratoga, CA (US); Saeid Ghafouri, Saratoga, CA (US)

(73) Assignee: ICELERO INC, San Jose, CA (US)

(21) Appl. No.: 14/124,466

(22) PCT Filed: Jun. 16, 2012
(86) PCT No.: PCT/US2012/042838

§ 371 Date: Jan. 14, 2014

Related U.S. Application Data
(60) Provisional application No. 61/498,552, filed on Jun. 18, 2011.

(51) Int. Cl. G06Q 20/22

(52) U.S. Cl. CPC G06Q 20/227
USPC 705/39

(57) ABSTRACT

A system, method and computer program product for processing payments, including a server in an electronic device and/or a server in a remote location; a database in the electronic device and/or a database in a remote location coupled to the respective server; and an electronic device of a consumer coupled to the server over a communications network, wherein the server is configured to determine a payment option most advantageous to the consumer based on information stored in the database regarding a plurality of payment options available to the consumer, and the server is configured to display the most advantageous payment option to the consumer on the electronic device of the consumer.

### CROSS REFERENCE TO RELATED DOCUMENTS

The present invention claims benefit of priority to U.S. Provisional Patent Application Ser. No. 61/498,552 of Amit RAMCHANDRAN et al., entitled “A PROCESS FOR DETERMINING THE MOST REWARDING CHOICE OF PAYMENT AT ANY POINT OF SALE,” filed on Jun. 18, 2011, the entire disclosure of which is hereby incorporated by reference herein.

### BACKGROUND OF THE INVENTION

1. Field of the Invention

The present invention generally relates to systems and methods for commerce payments, and more particularly to systems and methods for determining a most rewarding choice of payment at a point-of-sale, and the like.

2. Discussion of the Background

In recent years, consumers have been provided with a number of choices for completing a purchase at a point-of-sale, such as over the Internet, at a physical store, and the like, including credit cards, checks, debit cards, coupons, gift cards, cash, and the like. Typically, one or more of such payment choices have associated rewards, points, discounts, lower fees, interest rates, and the like, associated with such payment choices and that are changed frequently by merchants, financial institutions, and the like.

However, with such payment systems and methods, there is still a need for determining the most rewarding choice of payment for a user at a point-of-sale.

### SUMMARY OF THE INVENTION

Therefore, there is a need for a method and system that address the above and other problems with payment systems and methods. The above and other needs are addressed by the illustrative embodiments of the present invention, which provide a novel method and system for determining a most rewarding choice of payment for a user at a point-of-sale, and the like.

Accordingly, in an illustrative aspect, there is provided a system, method and computer program product for processing payments, including a server in an electronic device and/or a server in a remote location; a database in the electronic device and/or a database in a remote location coupled to the respective server; and an electronic device of a consumer coupled to the server over a communications network.

The server can be configured to determine a payment option most advantageous to the consumer based on information stored in the database regarding a plurality of payment options available to the consumer.

The server can be configured to display the most advantageous payment option to the consumer on the electronic device of the consumer.

The plurality of payment options can include online merchant websites, social media websites, physical stores, financial institutions, and profit or non-profit institutions.

The information stored in the database regarding the plurality of payment options can include available payment instruments for the consumer, payment locations, and payment preferences of the consumer.

Still other aspects, features, and advantages of the present invention are readily apparent from the following detailed description, simply by illustrating a number of illustrative embodiments and implementations, including the best mode contemplated for carrying out the present invention. The present invention also is capable of other and different embodiments, and its several details can be modified in various respects, all without departing from the spirit and scope of the present invention. Accordingly, the drawings and descriptions are to be regarded as illustrative in nature, and not as restrictive.

### BRIEF DESCRIPTION OF THE DRAWINGS

The embodiments of the present invention are illustrated by way of example, and not by way of limitation, in the figures of the accompanying drawings, in which like reference numerals refer to similar elements, and in which:

FIG. 1 is an illustrative system and method for determining a most rewarding choice of payment for a consumer at a point-of-sale; and

FIG. 2 is an illustrative flow chart for determining a most rewarding choice of payment for a consumer at a point-of-sale.

### DETAILED DESCRIPTION OF THE PREFERRED EMBODIMENTS

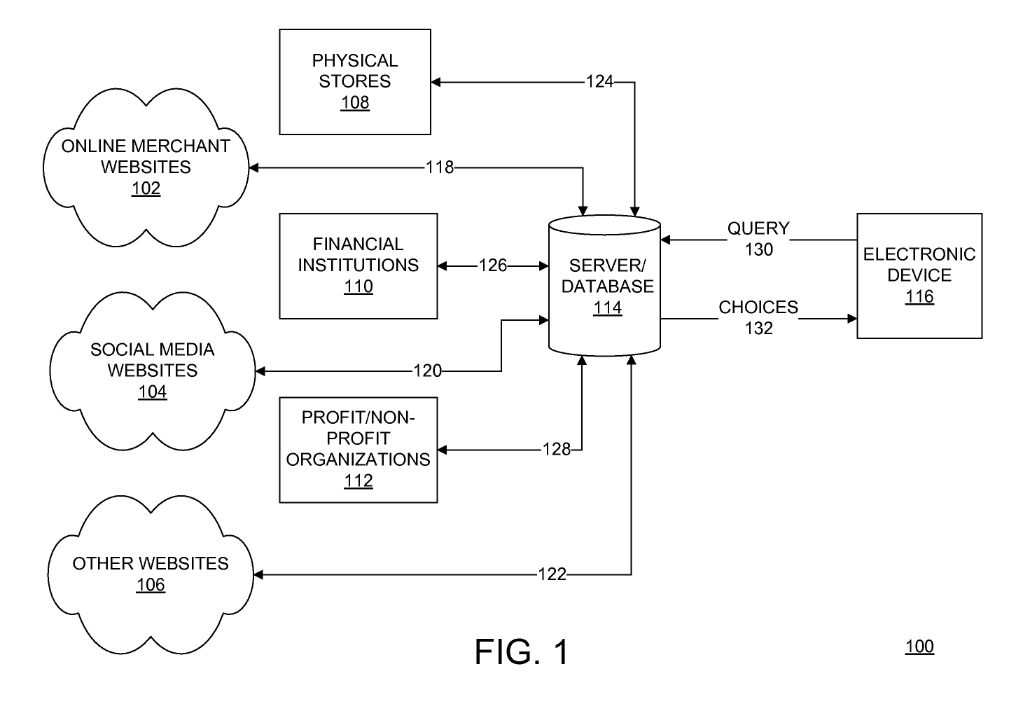

Referring now to the drawings, in FIG. 1 there is shown an illustrative system and method 100 for determining a most rewarding choice of payment for a consumer at a point-of-sale, and the like. In FIG. 1, the system 100 can include a consumer electronic device 116, such as servers in data centers, personal computers, netbooks, personal media players, cell phones, phones, consumer electronic devices, and the like. The electronic device 116 is physically or wirelessly connected to a server/database 114.

The server/database 114 can have multiple instances and can be physically located inside the electronic device 116 and/or in a remote location, and the like. Inside the electronic device, the server/database can be implemented either in hardware or software. The server/database 114 can be created manually or in an automated manner. The server/database 114 receives input factors that may help influence the choice of instrument for completing a payment from a number of sources, including online merchant websites 102, social media websites 104, any other suitable websites 106, physical stores 108, financial institutions 110, any other suitable institution for profit or non-profit 112, and the like. When located inside the device, the server/database 114 also receives information about available payment instruments for the consumer, locations, user preferences, and the like, from the consumer via the electronic device 116.

Based on a query 130 sent via the electronic device 116 to the server/database 114, a list of most rewarding payment choices 132 for completing any suitable transaction are provided to the consumer. The server/database 114 can also generate additional offers, advertisements, other suitable messages, and the like, for display to the consumer via the electronic device 116. The elements 118, 120, 122, 124, 126, 128, 130, and 132 can include voice communications, video communications, text communications, other suitable forms of data communications, and the like.

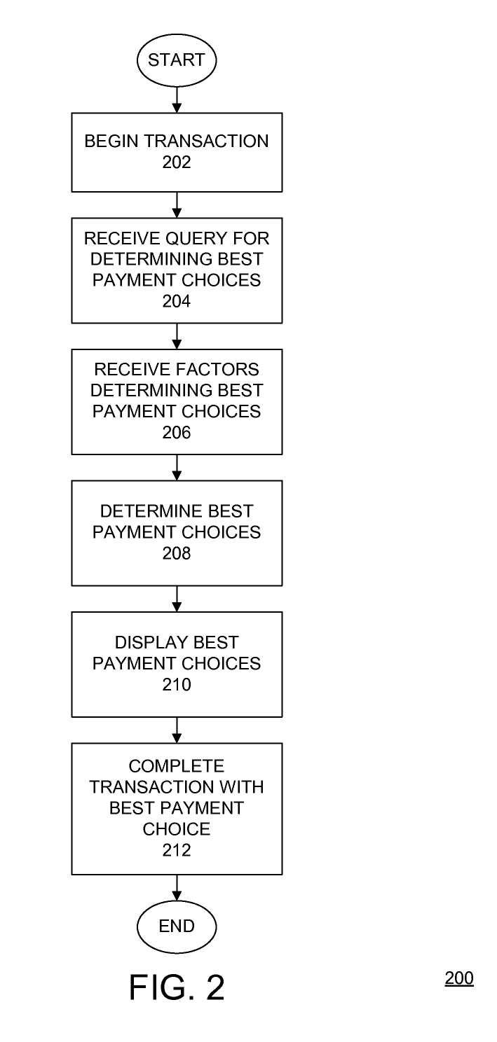

FIG. 2 is an illustrative flow chart for determining a most rewarding choice of payment for a consumer at a point-of-sale. In FIG. 2, the process 200 includes a consumer beginning a transaction at a point-of-sale at step 202. At step 204, the electronic device 116 receives the query 130 from the consumer. At step 206, the server/database 114 queries and/or receives the input factors for determining the best payment choice for the consumer from the online merchant websites 102, the social media websites 104, the other suitable websites 106, the physical stores 108, the financial institutions 110, and/or the other suitable institution for profit or non-profit 112. The server/database 114 also receives information about available payment instruments for the consumer, locations, user preferences, and the like, from the consumer via the electronic device 116. At step 208, based on the input factors and information, the server/database 114 determines the best choices for payment for the consumer. At step 210, the server/database 114 sends the list of the most rewarding payment choices 132 for completing the transaction to the electronic device 116 and which are provided, displayed, and the like, to the consumer by the electronic device 116. The server/database 114 can also generate additional offers, advertisements, other suitable messages, and the like, for display to the consumer via the electronic device 116. At step 212, the consumer completes the transaction, manually or automatically via the electronic device 116, based a selection of a payment choice from the list of the most rewarding payment choices 132, completing the process.

Thus, the present invention includes a system and method for determining for a consumer a form of payment from among a plurality of payment choices available to the consumer at a point-of-sale, such as over the Internet, at a physical store, and the like, based on a number of factors, including payment choices, such as credit cards, checks, debit cards, coupons, gift cards, cash, and the like. Such payment choices can include those already available to the consumer, new payment choices that may become available. The system and method are applicable to transactions at a physical store, a virtual location on an Internet site, and the like, which represent the point-of-sale. Such payment choices can include rewards associated with the various forms of payments, interest rates associated with the various forms of payments, coupons that the consumer possesses, coupons that the consumer may not possesses, discounts when one or more products are combined, offers from other stores or sites that want to reward the consumer for the present transaction, and the like. The most rewarding choice can further be determined based on consumer behavior, including spending and/or paying habits, consumer interests, and the like, and other suitable factors that may influence the most rewarding choice for the consumer, and the like.

The above-described devices and subsystems of the illustrative embodiments of FIGS. 1-2 can include, for example, any suitable servers, workstations, PCs, laptop computers, PDAs, Internet appliances, handheld devices, cellular telephones, wireless devices, other electronic devices, and the like, capable of performing the processes of the illustrative embodiments of FIGS. 1-2. The devices and subsystems of the illustrative embodiments of FIGS. 1-2 can communicate with each other using any suitable protocol and can be implemented using one or more programmed computer systems or devices.

One or more interface mechanisms can be used with the illustrative embodiments of FIGS. 1-2, including, for example, Internet access, telecommunications in any suitable form (e.g., voice, modem, and the like), wireless communications media, and the like. For example, employed communications networks or links can include one or more wireless communications networks, cellular communications networks, cable communications networks, satellite communications networks, G3 communications networks, Public Switched Telephone Network (PSTNs), Packet Data Networks (PDNs), the Internet, intranets, WiMax Networks, a combination thereof, and the like.

It is to be understood that the devices and subsystems of the illustrative embodiments of FIGS. 1-2 are for illustrative purposes, as many variations of the specific hardware and/or software used to implement the illustrative embodiments are possible, as will be appreciated by those skilled in the relevant art(s). For example, the functionality of one or more of the devices and subsystems of the illustrative embodiments of FIGS. 1-2 can be implemented via one or more programmed computer systems or devices.

To implement such variations as well as other variations, a single computer system can be programmed to perform the special purpose functions of one or more of the devices and subsystems of the illustrative embodiments of FIGS. 1-2. On the other hand, two or more programmed computer systems or devices can be substituted for any one of the devices and subsystems of the illustrative embodiments of FIGS. 1-2. Accordingly, principles and advantages of distributed processing, such as redundancy, replication, and the like, also can be implemented, as desired, to increase the robustness and performance the devices and subsystems of the illustrative embodiments of FIGS. 1-2.

The devices and subsystems of the illustrative embodiments of FIGS. 1-2 can store information relating to various processes described herein. This information can be stored in one or more memories, such as a hard disk, optical disk, magneto-optical disk, RAM, and the like, of the devices and subsystems of the illustrative embodiments of FIGS. 1-2. One or more databases of the devices and subsystems of the illustrative embodiments of FIGS. 1-2 can store the information used to implement the illustrative embodiments of the present invention. The databases can be organized using data structures (e.g., records, tables, arrays, fields, graphs, trees, lists, and the like) included in one or more memories or storage devices listed herein. The processes described with respect to the illustrative embodiments of FIGS. 1-2 can include appropriate data structures for storing data collected and/or generated by the processes of the devices and subsystems of the illustrative embodiments of FIGS. 1-2 in one or more databases thereof.

All or a portion of the devices and subsystems of the illustrative embodiments of FIGS. 1-2 can be conveniently implemented using one or more general purpose computer systems, microprocessors, digital signal processors, micro-controllers, application processors, domain specific processors, application specific signal processors, and the like, programmed according to the teachings of the illustrative embodiments of the present invention, as will be appreciated by those skilled in the computer and software arts. Appropriate software can be readily prepared by programmers of ordinary skill based on the teachings of the illustrative embodiments, as will be appreciated by those skilled in the software art. In addition, the devices and subsystems of the illustrative embodiments of FIGS. 1-2 can be implemented by the preparation of application-specific integrated circuits or by interconnecting an appropriate network of conventional component circuits, as will be appreciated by those skilled in the electrical art(s). Thus, the illustrative embodiments are not limited to any specific combination of hardware circuitry and/or software.

Stored on any one or on a combination of computer readable media, the illustrative embodiments of the present invention can include software for controlling the devices and subsystems of the illustrative embodiments of FIGS. 1-2, for driving the devices and subsystems of the illustrative embodiments of FIGS. 1-2, for enabling the devices and subsystems of the illustrative embodiments of FIGS. 1-2 to interact with a human user, and the like. Such software can include, but is not limited to, device drivers, firmware, operating systems, development tools, applications software, and the like. Such computer readable media further can include the computer program product of an embodiment of the present invention for performing all or a portion (if processing is distributed) of the processing performed in implementing the illustrative embodiments of FIGS. 1-2. Computer code devices of the illustrative embodiments of the present invention can include any suitable interpretable or executable code mechanism, including but not limited to scripts, interpretable programs, dynamic link libraries (DLLs), Java classes and applets, complete executable programs, Common Object Request Broker Architecture (CORBA) objects, and the like. Moreover, parts of the processing of the illustrative embodiments of the present invention can be distributed for better performance, reliability, cost, and the like.

As stated above, the devices and subsystems of the illustrative embodiments of FIGS. 1-2 can include computer readable medium or memories for holding instructions programmed according to the teachings of the present invention and for holding data structures, tables, records, and/or other data described herein. Computer readable medium can include any suitable medium that participates in providing instructions to a processor for execution. Such a medium can take many forms, including but not limited to, non-volatile media, volatile media, transmission media, and the like. Non-volatile media can include, for example, optical or magnetic disks, magneto-optical disks, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, and the like. Common forms of computer-readable media can include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave, or any other suitable medium from which a computer can read.

While the present invention have been described in connection with a number of illustrative embodiments and implementations, the present invention is not so limited, but rather covers various modifications and equivalent arrangements, which fall within the purview of the appended claims.

What is claimed is:

1. A system for processing payments, the system comprising:
a server in an electronic device and/or a server in a remote location;
a database in the electronic device and/or a database in a remote location coupled to the respective server; and
an electronic device of a consumer coupled to the server over a communications network,
wherein the server is configured to determine a payment option most advantageous to the consumer based on information stored in the database regarding a plurality of payment options available to the consumer, and
the server is configured to display the most advantageous payment option to the consumer on the electronic device of the consumer.

2. The system of claim 1, wherein the plurality of payment options include online merchant websites, social media websites, physical stores, financial institutions, and profit or non-profit institutions.

3. The system of claim 1, wherein the information stored in the database regarding the plurality of payment options includes available payment instruments for the consumer, payment locations, and payment preferences of the consumer.

4. A computer implemented method for processing payments via a server in an electronic device and/or a server in a remote location, a database in the electronic device and/or a database in a remote location coupled to the respective server, and an electronic device of a consumer coupled to the server over a communications network, the method comprising:
determining via the server a payment option most advantageous to the consumer based on information stored in the database regarding a plurality of payment options available to the consumer, and
displaying to the consumer on the electronic device of the consumer via the server the most advantageous payment option.

5. The method of claim 4, wherein the plurality of payment options include online merchant websites, social media websites, physical stores, financial institutions, and profit or non-profit institutions.

6. The method of claim 4, wherein the information stored in the database regarding the plurality of payment options includes available payment instruments for the consumer, payment locations, and payment preferences of the consumer.

7. A computer program product for processing payments via a server in an electronic device and/or a server in a remote location, a database in the electronic device and/or a database in a remote location coupled to the respective server, and an electronic device of a consumer coupled to the server over a communications network, and including one or more computer readable instructions embedded on a non-transitory, tangible computer readable medium and configured to cause one or more computer processors to perform the steps of:
determining via the server a payment option most advantageous to the consumer based on information stored in the database regarding a plurality of payment options available to the consumer, and
displaying to the consumer on the electronic device of the consumer via the server the most advantageous payment option.

8. The computer program product of claim 7, wherein the plurality of payment options include online merchant websites, social media websites, physical stores, financial institutions, and profit or non-profit institutions.

9. The computer program product of claim 7, wherein the information stored in the database regarding the plurality of payment options includes available payment instruments for the consumer, payment locations, and payment preferences of the consumer.
